(19) United States
(12) Patent Application Publication
(10) Pub. No.: US 2020/0056085 A1
(43) Pub. Date: Feb. 20, 2020

(54) BASIL SEED GUM POLYMER GELLING AGENT

(71) Applicant: Halliburton Energy Services, Inc., Houston, TX (US)

(72) Inventors: Sairam Eluru, Pune (IN); Pratiksha Shivaji Meher, Pune (IN); Mallikarjuna Shroff Rama, Pune (IN); Rajender Salla, Pune (IN)

(21) Appl. No.: 16/485,709

(22) PCT Filed: Apr. 25, 2017
(86) PCT No.: PCT/US2017/029329

§ 371 Date: Aug. 13, 2019

(51) Int. Cl. C09K 8/514; C09K 8/512; C09K 8/575; C09K 8/68; C09K 8/88; C09K 8/90; C09K 8/80

(52) U.S. Cl. CPC C09K 8/514; C09K 8/512; C09K 8/5756; C09K 8/5758; C09K 2208/26; C09K 8/887; C09K 8/90; C09K 8/80; C09K 8/685

(57) ABSTRACT

A well treatment fluid comprising an aqueous base fluid and polymer gelling agent is provided. The polymer gelling agent is selected from the group of basil seed gum, derivatives of basil seed gum, and combinations thereof. Also provided is a method of treating a well. In one embodiment, for example, the method is a method of fracturing a subterranean formation. In another embodiment, for example, the method is a method of forming a gravel pack in a well.

### BACKGROUND

Gelling agents are used in a variety of applications in the oil and gas field. For example, gelling agents are commonly used in drilling fluids, stimulation fluids and other well treatment fluids to increase the viscosity and otherwise modify the rheology of the fluids without changing other properties of the fluids. Most gelling agents can be crosslinked to further increase the viscosity of the well treatment fluids. The gels formed by gelling agents in well treatment fluids eventually break or can be caused to break in order to reduce the viscosity of the fluids and allow the fluids to be more easily removed from the well.

Examples of gelling agents that are currently used include polyacrylamide and other acrylamide-based gelling agents, guar and guar derivatives, including hydroxy propyl guar, carboxymethyl guar and carboxymethyl hydroxyl propyl guar, cellulose and cellulose derivatives, xanthan, diutane, hydroxypropyl cellulose phosphate, hydroxypropyl starch phosphate and combinations thereof. In addition, complex synthetic polymers have been developed for use as gelling agents in well treatment fluids.

In drilling a well, a drilling fluid (for example, an aqueous-based drilling mud) is typically circulated from the surface through the drill string and drill bit and back to the surface through the annulus between the drill string and the borehole wall. The drilling fluid functions, for example, to cool, lubricate and support the drill bit, remove cuttings from the wellbore, control formation pressures, and maintain the stability of the wellbore.

For example, gelling agents are added to drilling fluids to increase the viscosity of the fluids. The increased viscosity of the fluids helps suspend and prevent settling of weighting agents, drill cuttings and other components therein.

In a hydraulic fracturing operation, a fracturing fluid is pumped into a subterranean formation at a pressure sufficient to initiate or extend one or more fractures in the formation. Proppant particulates are placed in the fracture(s) to hold the fracture(s) open once the hydraulic pressure on the formation is released. Typically, a pad fracturing fluid (“a pad fluid”) that does not contain conventional or primary proppant particulates is first injected into the formation to initially fracture the formation. Thereafter, a slurry of proppant particulates (a “proppant slurry”) is injected into the formation. The proppant slurry places the proppant particulates in the fracture in order to prevent the fracture from fully closing once the hydraulic pressure created by the fluid is released and the fracturing operation is complete. The resulting propped fracture provides one or more conductive channels through which fluids in the formation can flow from the formation to the wellbore.

For example, gelling agents are added to fracturing fluids to increase the viscosity thereof. The increased viscosity of the fracturing fluids makes it easier to fracture the formation and helps suspend and prevent settling of proppant particulates in the fracturing fluid.

In a gravel pack operation, a gravel pack is installed proximate to an unconsolidated or loosely consolidated production interval to mitigate the production of relatively fine particulate materials (such as sand) during the production phase. For example, if not controlled, produced sand or other particulate material can cause abrasive wear to components within the well. In addition, the particulate material can clog the well, creating the need for an expensive workover. Also, if the particulate material is produced to the surface, it has to be removed from the produced hydrocarbon fluids.

In a typical gravel pack operation, a sand control screen or slotted liner is lowered into the wellbore on a work string to a desired position proximate to the production interval at issue. A gravel packing fluid containing a base liquid and a relatively large particulate material known in the art as gravel (for example, large grain sand) is then pumped down the work string and into the well annulus formed between the sand control screen and the perforated well casing or open hole production zone. The base liquid of the gravel packing fluid either flows into the formation or returns to the surface by flowing through the sand control screen or both. In either case, the gravel is deposited concentrically around the sand control screen to form a gravel pack, which is highly permeable to the flow of hydrocarbon fluids yet blocks the flow of the particulate material carried by the hydrocarbon fluids. As a result, gravel packs can successfully prevent the problems associated with the production of sand and other particulate material from the formation.

For example, gelling agents are added to gravel packing fluids in order to increase the viscosity of the fluids. The increased viscosity of the gravel packing fluids helps suspend and prevent settling of the gravel in the fluid.

An important property of gelling agents in many applications is thermo-thickening or thermo-viscosifying (hereafter “thermo-thickening”). A gelling agent that is thermo-thickening by nature increases the viscosity of the well treatment fluid with increasing temperature, at least up to a point (at temperatures above 400° F., for example, bonds in the gelling agent may begin to break which can reduce the viscosity of the fluid). A thermo-thickening gelling agent allows the viscosity of the well treatment fluid to be initially maintained at a relatively low level in order to facilitate pumping of the fluid into the formation. Once the well treatment fluid encounters higher temperatures downhole and in the formation, the viscosity of the fluid increases. Other properties of a gelling agent are important as well.

In view of the importance of gelling agents in oil and gas well applications, there is a need for new gelling agents that have enhanced properties.

### BRIEF DESCRIPTION OF THE DRAWINGS

The drawings included with this application illustrate certain aspects of the embodiments described herein. However, the drawings should not be viewed as exclusive embodiments. The subject matter disclosed herein is capable of considerable modifications, alterations, combinations, and equivalents in form and function, as will be evident to those skilled in the art with the benefit of this disclosure.

FIG. 1 is a diagram illustrating an example of a fracturing system that can be used in accordance with certain embodiments of the present disclosure.

FIG. 2 is a diagram illustrating an example of a subterranean formation in which a fracturing operation can be performed in accordance with certain embodiments of the present disclosure.

FIG. 3 is graph corresponding to Example 2 and illustrating shear thinning properties of basil seed gum gels at different concentrations (0.1-2%).

FIG. 4 is graph corresponding to Example 3 and illustrating shear thinning properties of a basil seed gum gel to gels formed with other gelling agents.

FIG. 5 is graph corresponding to Example 4 and illustrating the rheological behavior of a 1% basil seed gum gel at 180° F. and 100 s⁻¹.

FIG. 6 is graph corresponding to Example 4 and illustrating the rheological behavior of a 1% basil seed gum gel at 200° F. and 100 s⁻¹.

FIG. 7 is graph corresponding to Example 4 and illustrating the temperature sweep of a 1% basil seed gum solution at 0.5% strain and 1 Hz frequency.

### DETAILED DESCRIPTION

The present disclosure may be understood more readily by reference to this detailed description as well as to the examples included herein. For simplicity and clarity of illustration, where appropriate, reference numerals may be repeated among the different figures to indicate corresponding or analogous elements. In addition, numerous specific details are set forth in order to provide a thorough understanding of the examples described herein. However, it will be understood by those of ordinary skill in the art that the examples described herein can be practiced without these specific details. In other instances, methods, procedures and components have not been described in detail so as not to obscure the related relevant feature being described. Also, the description is not to be considered as limiting the scope of the examples described herein. The drawings are not necessarily to scale and the proportions of certain parts have been exaggerated to better illustrate details and features of the present disclosure.

In accordance with the present disclosure, a well treatment fluid and a method of treating a well are provided. Unless stated otherwise, as used herein and in the appended claims, a “well” means a wellbore extending into the ground and a subterranean formation penetrated by the wellbore. For example, a well can be an oil well, a natural gas well, a water well or any combination thereof. A “well treatment fluid” means any fluid that is introduced into a well to treat the well or the subterranean formation.

### Well Treatment Fluid

The well treatment fluid disclosed herein comprises an aqueous base fluid and a polymer gelling agent. For example, the well treatment fluid can be an injection fluid, a drilling mud or other drilling fluid, a pre-flush fluid, a cement composition, a fracturing, acidizing or other stimulation fluid, a gravel packing fluid, a completion fluid, or a work-over fluid. For example, the well treatment fluid disclosed herein can be a hydraulic fracturing fluid or a gravel packing fluid.

For example, the aqueous base fluid of the well treatment fluid disclosed herein can be water. The water can come from a variety of sources. For example, the water can be fresh water. For example, the water can be salt-containing water. Examples of salt-containing water include saltwater, brine (for example, saturated saltwater or produced water), seawater, brackish water, produced water (for example, water produced from a subterranean formation), formation water, treated flowback water, and any combination thereof.

As used herein and in the appended claims, a “polymer gelling agent” means a polymer that forms a gel when combined with an aqueous base fluid. The polymer gelling agent can be in the form of a dry powder, or can be in the form of a liquid gel concentrate.

The polymer gelling agent of the well treatment fluid disclosed herein is selected from the group of basil seed gum, derivatives of basil seed gum, and combinations thereof. For example, the polymer gelling agent of the well treatment fluid disclosed herein is basil seed gum.

Basil is a culinary herb, native to India. Basil seed gum is a hydrocolloid extracted from basil (Ocimum basilicum L). It is a carbohydrate high polymer that is insoluble in alcohol and other organic solvents but generally soluble or dispersible in water. For example, basil seed gum includes two major fractions of glucomannan, (1→4)-linked xylan and a minor fraction of glucan (highly branched arabinogalactan).

For example, the general composition of basil seed gum is shown by Table 1 below:

TABLE 1
General Composition of Basil Seed Gum

| Name | % (wt/wt) |
|---|---|
| Total carbohydrate | 79.63 |
| Moisture | 9.10 |
| Starch | 1.53 |
| Ash | 5.32 |
| Protein | 1.32 |
| Fat Content | 5.38 |
| Soluble sugars | 0.55 |

As used herein and in the appended claims, a “derivative of basil seed gum” means a basil seed gum compound having one or more organic functional groups attached thereto. For example, the organic functional group(s) can be selected from hydroxypropyl groups, carboxymethyl hydroxypropyl groups and combinations thereof. For example, such basil seed gum derivatives can function to further increase the viscosity of the well treatment fluid when the basil seed gum is crosslinked with metal crosslinkers such as zirconium crosslinkers and titanium crosslinkers.

The polymer gelling agent of the well treatment fluid disclosed herein has many important and collectively unique properties. For example, it is thermo-thickening in that it increases the viscosity of the well treatment fluid in response to increasing temperature. This allows the polymer gelling agent to maintain the viscosity of the well treatment fluid at a relatively low level as the fluid is pumped down the wellbore yet significantly increase the viscosity of the fluid as it encounters higher temperatures, for example, in the formation. The polymer gelling agent is also shear thinning in that it allows the viscosity of the well treatment fluid to be decreased upon the application of shear forces thereto. For example, due to the shear forces placed on the well treatment fluid by the pumping process, the shear thinning nature of the polymer gelling agent allows the pumping pressures required in hydraulic fracturing applications to be reduced. Even under low shear conditions, however, the viscosity of the gelled well treatment fluid remains relatively high. For example, this helps with proppant particulate and gravel suspension in hydraulic fracturing and gravel packing applications, respectively.

The polymer gelling agent of the well treatment fluid disclosed herein also has a high tolerance for salt which allows it to be used in connection with aqueous base fluids that contain salt (for example, seawater and/or produced water). The polymer gelling agent also cleanly breaks (or can be cleanly broken). Due to the fact that it is a plant derivative, basil seed gum is a bio-based food grade additive. As a result, basil seed gum has a low toxicity and is environmentally friendly. Due to the fact that it is naturally available, the polymer gelling agent disclosed herein is relatively simple compared to synthetic polymer gelling agents.

Due to the above properties, the polymer gelling agent of the well treatment fluid disclosed herein serves as an effective gelling agent for use in a variety of different types of oil and gas well treatment fluids and applications. For example, the polymer gelling agent is particularly useful in fracturing and gravel packing applications.

The exact amount of the polymer gelling agent present in the well treatment fluid disclosed herein can vary depending on the additional components of the well treatment fluid and the particular application. For example, the polymer gelling agent is generally present in the well treatment fluid in an amount in the range of from about 0.001% by weight to about 10% by weight, based on the total weight of the well treatment fluid. For example, the polymer gelling agent is present in the well treatment fluid in an amount in the range of from about 0.01% by weight to about 5% by weight, based on the total weight of the well treatment fluid. For example, the polymer gelling agent is present in the well treatment fluid in an amount in the range of from about 0.05% by weight to about 3% by weight, based on the total weight of the well treatment fluid.

As will be understood by those skilled in the art with the benefit of this disclosure, depending on the purpose of the well treatment fluid, the characteristics of and conditions associated with the well and other factors, the well treatment fluid disclosed herein can further comprise one or more additional components.

For example, although the polymer gelling agent of the well treatment fluid is selected from the group of basil seed gum, derivatives of basil seed gum, and combinations thereof, the well treatment fluid can further comprise other polymer gelling agents as well. Examples include polyacrylamide, guar and guar derivatives, cellulose and cellulose derivatives, xanthan, diutane, hydroxypropyl cellulose phosphate, and hydroxypropyl starch phosphate.

For example, the well treatment fluid disclosed herein can further comprise a gel stabilizer to stabilize the gel framed in the well treatment fluid by the polymer gelling agent. For example, the gel stabilizer can be selected from the group of sodium thiosulfate, isoascorbate, erythroborate, and any combination thereof.

The amount of the gel stabilizer added to the well treatment fluid can vary depending on the amount of the polymer gelling agent present in the well treatment fluid, the conditions of the well, the particular application and other factors known to those skilled in the art with the benefit of this disclosure. For example, the gel stabilizer can be included in the well treatment fluid in an amount in the range of from about 0.001% to about 3% by weight, based on the weight of the aqueous base fluid. For example, the gel stabilizer may be included in the well treatment fluid in an amount in the range of from about 0.01% to about 2% by weight, based on the weight of the aqueous base fluid. For example, the gel stabilizer may be included in the well treatment fluid in an amount in the range of from about 0.1% to about 1% by weight, based on the weight of the aqueous base fluid.

For example, the well treatment fluid disclosed herein can further comprise a gel crosslinker to crosslinker the polymer gelling agent of the well treatment fluid and thereby further increase the viscosity of the well treatment fluid. The gel crosslinker can be any gel crosslinker known to those skilled in the art with the benefit of this disclosure to crosslink a polymer gelling agent and thereby enhance the viscosity of the well treatment fluid. Individuals skilled in the art, with the benefit of this disclosure, will recognize the exact type and amount of crosslinker to use, depending on factors such as the specific components used, the desired viscosity, and formation conditions.

Examples of gel crosslinkers that can be used include boron compounds such as boric acid, disodium octaborate tetrahydrate, sodium diborate, pentaborates, ulexite and colemanite, zirconium compounds such as zirconium compounds that can supply zirconium IV ions, including, for example, zirconium lactate, zirconium acetate lactate, zirconium lactate triethanolamine, zirconium carbonate, zirconium acetylacetonate, zirconium malate, zirconium citrate, and zirconium diisopropylamine lactate, titanium compounds such as compounds that can supply titanium IV ions, including, for example, titanium lactate, titanium malate, titanium citrate, titanium ammonium lactate, titanium triethanolamine, and titanium acetylacetonate, aluminum compounds such as aluminum lactate and aluminum citrate, antimony compounds, chromium compounds, iron compounds, copper compounds, zinc compounds, and any combination thereof. For example, the gel crosslinker can be selected from the group of boron compounds, zirconium compounds, and any combination thereof. For example, the gel crosslinker can be a crosslinker selected from the group of boric acid, disodium octaborate tetrahydrate, sodium diborate, pentaborates, ulexite, colemanite, zirconium lactate, zirconium acetate lactate, zirconium lactate triethanolamine, zirconium carbonate, zirconium acetylacetonate, zirconium malate, zirconium citrate, and zirconium diisopropylamine lactate, and any combination thereof.

The gel crosslinker described above crosslinkers the polymer gelling agent to form a crosslinked gel and thereby further increases the viscosity of the well treatment fluid. For example, when crosslinked with a gel crosslinker as described above, the polymer gelling agent of the well treatment fluid disclosed herein forms a substantially dilute crosslinked system which exhibits no flow when in the steady state. The crosslinked gel is mostly liquid yet behaves like a solid due to a three-dimensional crosslinked network with the liquid.

The amount of the gel crosslinker added to the well treatment fluid can vary depending on the amount of the polymer gelling agent present in the well treatment fluid, the well conditions, the particular application and other factors known to those skilled in the art with the benefit of this disclosure. For example, the gel crosslinker can be included in the well treatment fluid in an amount in the range of from about 0.0001% to about 3% by weight, based on the weight of the aqueous base fluid. For example, the gel crosslinker can be included in the well treatment fluid in an amount in the range of from about 0.001% to about 1% by weight, based on the weight of the aqueous base fluid. For example, the gel crosslinker can be included in the well treatment fluid in an amount in the range of from about 0.001% to about 0.4% by weight, based on the weight of the aqueous base fluid.

An example of a suitable commercially available borate-based crosslinker is “BC-140™,” a crosslinker available from Halliburton Energy Services, Inc. of Duncan, Okla. An example of a suitable commercially available zirconium-based crosslinker is “CL-24™,” a crosslinker available from Halliburton Energy Services, Inc. of Duncan, Okla. An example of a suitable commercially available titanium-based crosslinking agent is “CL-39™,” crosslinking agent available from Halliburton Energy Services, Inc. of Duncan, Okla.

For example, the well treatment fluid disclosed herein can further comprise a gel breaker to break the gel formed in the well treatment fluid by the polymer gelling agent (including the crosslinked portion of the gel and the gel itself). The gel breaker can be any gel breaker known to those skilled in the art with the benefit of this disclosure to break a crosslinked gel formed with a polymer gelling agent and thereby decrease the viscosity of the well treatment fluid. Any suitable gel breaker can be used, including encapsulated gel breakers and internal delayed gel breakers, such as enzyme, oxidizing, acid buffer, or temperature-activated gel breakers. Multiple gel breakers can be used. The gel breakers cause the viscous well treatment fluid to revert to a lower viscosity fluid that can be produced back to the surface after the well treatment fluid has been used to treat the well. For example, the gel breaker can be selected from the group of oxidizers, acids, acid releasing agents, enzymes, and any combination thereof. For example, the same gel breaker can be used for both crosslinked and non-crosslinked gels.

The amount of the gel breaker added to the well treatment fluid can vary depending on the amount of the polymer gelling agent present in the well treatment fluid, whether or not the gel is crosslinked, well conditions, the particular application and other factors known to those skilled in the art with the benefit of this disclosure. For example, the gel breaker can be added to the well treatment fluid in an amount in the range of from about 0.0001% by weight to about 10% by weight, based on the amount of the gelled fluid present in the well treatment fluid. For example, the gel breaker can be added to the well treatment fluid in an amount in the range of from about 0.001% by weight to about 10% by weight, based on the amount of the gelled fluid present in the well treatment fluid. For example, the gel breaker can be added to the well treatment fluid in an amount in the range of from about 0.01% by weight to about 10% by weight, based on the amount of the gelled fluid present in the well treatment fluid.

Additional components that can be included in the well treatment fluid disclosed herein include friction reducing agents, clay control agents, buffers and other pH adjusting agents, biocides, bactericides, scale inhibitors, weighting materials, fluid loss control additives, bridging materials, lubricants, corrosion inhibitors, non-emulsifiers, proppant particulates (including conventional or primary proppant particulates and micro-proppant particulates), and gravel for forming gravel packs. As will be understood by those skilled in the art with the benefit of this disclosure, the additional components and the amounts thereof that are utilized will vary depending on the particular application in which the well treatment fluid is used.

Examples of friction reducing agents that can be used include polysaccharides, polyacrylamides and combinations thereof. The polymer gelling agent of the well treatment fluid can also function to reduce friction.

Examples of clay control agents that can be included in the well treatment fluid include salts such as potassium chloride, sodium chloride, ammonium chloride, choline chloride, di-quaternary polymers and poly quaternary polymers.

Examples of buffers and other pH adjusting agents that can be included in the well treatment fluid include sodium hydroxide, potassium hydroxide, sodium carbonate, sodium bicarbonate, potassium carbonate, potassium bicarbonate, acetic acid, sodium acetate, sulfamic acid, hydrochloric acid, formic acid, citric acid, phosphonic acid, polymeric acids and combinations thereof. For example, the pH of the well treatment fluid can be adjusted to activate or deactivate a crosslinking agent or to activate a breaker.

Examples of biocides and bactericides that can be included in the well treatment fluid disclosed herein include 2,2-dibromo-3-nitrilopropionamide, 2-bromo-2-nitro-1,3-propanediol, sodium hypochlorite, and combinations thereof. For example, biocides and bactericides may be included in the fracturing fluid in an amount in the range of from about 0.001% to about 0.1% by weight, based on the weight of the aqueous base fluid.

Examples of scale inhibitors that can be included in the well treatment fluid disclosed herein include bis(hexamethylene triamine penta(methylene phosphonic acid)), diethylene triamine penta(methylene phosphonic acid), ethylene diamine tetra(methylene phosphonic acid), hexamethylenediamine tetra(methylene phosphonic acid), 1-hydroxyethylidene-1,1-diphosphonic acid, 2-hydroxyphosphonocarboxylic acid, 2-phosphonobutane-1,2,4-tricarboxylic acid, phosphino carboxylic acid, diglycol amine phosphonate, aminotris(methanephosphonic acid), methylene phosphonate, phosphonic acid, aminoalkylene phosphonic acid, aminoalkyl phosphonic acid, polyphosphate, salts of polyphosphate, and combinations thereof. For example, the scale inhibitors can be included in the fracturing fluid in an amount in the range of from about 0.001% to about 0.1% by weight, based on the weight of the aqueous base fluid.

Examples of weighting materials that can be included in the well treatment fluid disclosed herein include brines and other salts, barite, ferrite, and hematite.

Examples of fluid loss control agents and bridging materials that can be included in the well treatment fluid disclosed herein include metal carbonates, polylactic acid, polyvinyl alcohol, clays and other layered materials, and other suitable degradable particles.

Examples of lubricants that can be included in the well treatment fluid disclosed herein include surfactants, vegetable oils, mineral oils, synthetic oils, silicone oils and polymers.

Examples of corrosion inhibitors that can be included in the well treatment fluid disclosed herein include quaternary ammonium compounds, unsaturated carbonyl compounds, unsaturated ether compounds, and other corrosion inhibitors known by those skilled in the art with the benefit of this disclosure to be useful in connection with drilling fluids and fracturing fluids.

Examples of non-emulsifiers that can be included in the well treatment fluid disclosed herein include cationic, non-ionic, anionic, and zwitterionic non-emulsifiers. Specific examples of non-emulsifiers that can be used include a combination of terpene and an ethoxylated alcohol, ethoxylated nonyl phenols, octyl phenol polyethoxyethanol, potassium myristate, potassium stearylsulfate, sodium lauryl sulfonate, polyoxyethylene alkyl phenol, polyoxyethylene, polyoxyethylene (20 mole) stearyl ether, N-cetyl-N-ethyl morpholinium ethosulfate, and combinations thereof. For example, a non-emulsifier can be included in the well treatment fluid in an amount in the range of from about 0.001% to about 5% by weight, based on the weight of the aqueous base fluid.

Examples of primary proppant particulates that can be included in the well treatment fluid disclosed herein include the types of proppant particulates included in fracturing fluids, as discussed herein.

Examples of micro-proppant particulates that can be included in the well treatment fluid disclosed herein include the types of micro-proppant particulates included in fracturing fluids, as discussed herein.

Examples of gravel that can be included in the well treatment fluid disclosed herein include the types of gravel included in gravel packing fluids, as discussed herein.

For example, in one embodiment, the well treatment fluid is an aqueous-based drilling fluid for use in drilling wells into a subterranean formation. In addition to the aqueous base fluid and polymer gelling agent, the drilling fluid can include, for example, one or more weighting materials, fluid loss control additives, bridging materials, lubricants, corrosion inhibitors and/or suspending agents.

For example, in another embodiment, the well treatment fluid is an aqueous based fracturing fluid that can be pumped through the wellbore and into the formation at a sufficient pressure to fracture or extend an existing fracture in the formation. In addition to the aqueous base fluid and the polymer gelling agent, the fracturing fluid can include, for example, a plurality of proppant particulates for propping the fractures open.

For example, in another embodiment, the well treatment fluid is an aqueous based gravel packing fluid that can be pumped through the wellbore and into the formation to place gravel around a sand control screen in the formation. In addition to the aqueous base fluid and the polymer gelling agent, the gravel packing fluid can include, for example, gravel.

### Method

In another aspect, this disclosure provides a method of treating a well, comprising:

a. introducing a well treatment fluid into the well;

b. allowing a gel to form in the well treatment fluid;

c. allowing the gelled well treatment fluid to treat the well; and

d. breaking the gel in the well treatment fluid.

The well treatment fluid used in the method disclosed herein is the well treatment fluid described above and disclosed herein.

The well treatment fluid can be introduced into the well, for example, by pumping the well treatment fluid into the well using one or more pumps present on the well site as known to those skilled in the art with the benefit of this disclosure. The components of the well treatment fluid can be mixed together in any manner known to those skilled in the art with the benefit of this disclosure. For example, components can be mixed together using mixing equipment present on the well site. For example, components can be added to the well treatment fluid on the fly as the well treatment fluid is pumped into the wellbore.

A gel can be allowed to form in the well treatment fluid by mixing the aqueous base fluid, polymer gelling agent, gel stabilizer (if used), gel crosslinker (if used), and gel breaker (if used) of the well treatment fluid together. For example, the components of the well treatment fluid can be mixed together in a blender located on the site of the well. For example, the polymer gelling agent can be in the form of a dry powder or a liquid gel concentrate. Once it is mixed with the aqueous base fluid, a gel is formed.

The gelled well treatment fluid can be allowed to treat the well by pumping the well treatment fluid into the well under a sufficient hydraulic pressure and for a sufficient time to allow the well treatment fluid to treat the well. For example, if necessary, pumping can be stopped and the well can be shut in for an amount of time necessary to allow well treatment fluid to treat the well.

As used herein and in the appended claims, “breaking the gel” formed in the well treatment fluid means allowing the gel formed in the well treatment fluid to break or causing the gel formed in the well treatment fluid to break. For example, the gel formed in the well treatment fluid can be allowed to break on its own (without a gel breaker) due to the temperature or pH in the well or due to the elapse of time. For example, in some cases, exposure of the well treatment fluid to downhole temperatures can be sufficient to cause the gel to break. For example, the gel formed in the well treatment fluid can be caused to break by exposing the well treatment fluid to a gel breaker. For example, a gel breaker can be used to accelerate the gel breaking process initiated by the temperature in the wellbore.

Depending on the nature of the gel breaker, the gel breaker can be included in the initial well treatment fluid first introduced into the well or can be added to the well treatment fluid after the well treatment fluid is first introduced into the well. For example, gel breakers that are encapsulated or internal delayed can be mixed with the initial well treatment fluid first introduced into the well. The same gel breaker can work for both crosslinked and non-crosslinked gels.

Whether the gel is allowed to break or caused to break will vary depending on the amount of the polymer gelling agent used in the well treatment fluid, whether the polymer gelling agent is crosslinked, the well conditions, the particular application and other factors known to those skilled in the art with the benefit of this disclosure. Breaking of the gel lowers the viscosity of the well treatment fluid.

The method can further comprise removing the broken gel from the well. For example, the broken gel can be removed from the well by circulating an inert fluid through the wellbore to flush the well, by flowing back the well, or by other techniques known to those skilled in the art with the benefit of this disclosure.

In one embodiment, the method disclosed herein is a method of fracturing a subterranean formation. In this embodiment, the well treatment fluid is a fracturing fluid and further comprises a plurality of proppant particulates. The method comprises:
a. providing the fracturing fluid;
b. pumping the fracturing fluid into the formation at a pressure above the fracture gradient of the formation to form a fracture in the formation;
c. allowing a gel to form in the fracturing fluid;
d. placing proppant particulates in the fracture;
e. ceasing pumping of the fracturing fluid into the formation; and
f. breaking gel formed in the fracturing fluid.

As used herein and in the appended claims, the term “fracturing fluid” means a pad fracturing fluid, a proppant slurry or any other type of treatment fluid that is pumped into the subterranean formation at a pressure above the fracture gradient of the formation during a hydraulic formation fracturing operation. The term “pad fracturing fluid” means a fracturing fluid that does not include primary proppant particulates. A pad fracturing fluid is typically used to initiate the fracture or fracture network and is injected into the formation in multiple stages. The term “proppant slurry” means a fracturing fluid that does include primary proppant particulates. A proppant slurry is typically used after a fracture or fracture network is initiated in the formation and is injected into the formation in multiple stages. A “propped fracture” means a fracture (naturally-occurring or otherwise) in a subterranean formation that contains a plurality of micro-proppant particulates or primary proppant particulates.

The fracturing fluid can be provided, for example, by mixing the components of the fracturing fluid together at the site of the well as described above and known to those skilled in the art with the benefit of this disclosure. For example, the proppant particulates can be included in the fracturing fluid in an amount at least sufficient to place proppant particulates in the fracture.

The fracturing fluid can be pumped into the formation at a pressure above the fracture gradient of the formation to form a fracture in the formation in any manner known to those skilled in the art with the benefit of this disclosure. As used herein and in the appended claims, the “fracture gradient” of a formation means the minimum pressure required to create a new fracture or expand an existing fracture in some dimension in the formation. “Forming a fracture in the formation” means forming a new fracture or expanding an existing fracture in some dimension in the formation.

In carrying out the above method, the fracturing fluid is pumped through the wellbore and through one or more access conduits into the formation. As used herein and in the appended claims, the term “access conduit” refers to a passageway that provides fluid communication between the wellbore and the formation. Examples of access conduits include sliding sleeves, open holes, hydra-jetted holes and perforations. Access conduits can be formed in non-cased (open) areas and cased areas of the wellbore. The access conduits can extend through the casing wall (if present), cement used to hold the casing in place (if present) and the wellbore wall.

For example, pumping the fracturing fluid into the formation at a pressure above the fracture gradient of the formation in accordance with the disclosed method can form one or more primary fractures in the formation. For example, pumping the fracturing fluid into the formation at a pressure above the fracture gradient of the formation in accordance with the disclosed method can also form a fracture network in the formation that includes at least one primary fracture and at least one microfracture. Primary proppant particulates are typically only placed in the primary fracture.

As used herein and in the appended claims, “forming a fracture network in the formation” means forming a new fracture network or expanding an existing fracture network in some dimension in the formation. The fracture network can include primary fractures, branches of primary fractures, and microfractures, whether induced by the fracturing treatment or naturally occurring. The fracture network is formed within the formation and is in fluid communication with the wellbore. For example, the fracture network is typically framed in a zone of the formation that surrounds the wellbore and propagates from at least one access conduit outwardly from the wellbore. Microfractures tend to extend outwardly from the tip and edges of primary fractures and primary fracture branches in a branching tree-like manner. The microfractures can extend transversely to the trajectories of the primary fractures and primary fracture branches, allowing the primary fractures and primary fracture branches to reach and link natural fractures both in and adjacent to the trajectories of the primary fractures and primary fracture branches.

As used herein and in the appended claims, the term “primary fracture” means a fracture that extends from the wellbore and is of a size sufficient to allow primary proppant particulates to be placed therein. The term “microfracture” means a natural fracture existing in the formation, or an induced secondary or tertiary fracture, that extends from a primary fracture or a primary fracture branch and is not of a size sufficient to allow primary proppant particulates to be placed therein. Microfractures can exist and be formed in both near-wellbore and far-field regions of the zone. As a result, the microfractures can give more depth and breadth to the fracture network resulting in increased production of hydrocarbons when the well is produced. For example, the disclosed method may be used in connection with a subterranean formation and wellbore having an existing fracture network.

For example, a pad fracturing fluid can first be pumped into the formation in accordance with the disclosed method. At some point, the pad fracturing fluid can be transitioned to the proppant slurry without ceasing the pumping process or otherwise reducing the hydraulic pressure placed on the formation by the fracturing treatment. As known to those skilled in the art with the benefit of this disclosure, if needed or desired, a pill can be pumped into the formation following pumping of the pad fracturing fluid and prior to pumping of the proppant slurry in order to allow the transition from the pad fracturing fluid to the proppant slurry to be made.

A gel can be allowed to form in the fracturing fluid by mixing the aqueous base fluid, polymer gelling agent, gel stabilizer (if used), gel crosslinker (if used) and gel breaker (if used) of the well treatment fluid together, as described above.

The proppant particulates can be placed in the fracture in any manner known to those skilled in the art with the benefit of this disclosure. For example, proppant particulates can be placed in the fracture in accordance with the disclosed method by pumping the fracturing fluid into the formation for a sufficient time and at a sufficient pressure to cause the proppant particulates to be placed in the fracture. The hydraulic pressure placed on the formation forces the fracturing fluid and proppant particulates into the fracture. When the pressure is released on the fracturing fluid, the proppant particulates remain in the fracture. While in place, the proppant particulates hold the fracture open, thereby maintaining the ability for fluid to flow through the fracture to the wellbore.

As used herein and in the appended claims, the terms “primary proppant particulate” and “conventional proppant particulate” are used interchangeably and mean a proppant particulate having a D50 particle size distribution of equal to or greater than 100 microns. For example, the primary proppant particulates used in the disclosed method can have a D50 particle size distribution of in the range of from 100 microns to about 1200 microns, or any subset therebetween. For example, the primary proppant particulates used in the disclosed method have a D50 particle size distribution of in the range of from about 150 microns to about 750 microns, or any subset therebetween. For example, the primary proppant particulates used in the disclosed method have a D50 particle size distribution of in the range of from about 175 microns to about 400 microns, or any subset therebetween. Apart from the above definition of primary proppant particulates, the modifier “primary” should not be construed as limiting in any way.

As used herein and in the appended claims, the term “micro-proppant particulate” means a particulate having a D50 particle size distribution of less than 100 microns. For example, the micro-proppant particulates used in the disclosed method have a D50 particle size distribution of in the range of from about 1 micron to about 99 microns, or any subset therebetween. For example, the micro-proppant particulates used in the disclosed method have a D50 particle size distribution of in the range of from about 5 microns to about 75 microns, or any subset therebetween. For example, the micro-proppant particulates used in the disclosed method have a D50 particle size distribution of in the range of from about 5 microns to about 50 microns, or any subset therebetween.

As used herein and in the appended claims, the “D50 particle size distribution” of a particulate means the value of the particle diameter at 50% in the cumulative distribution. The size of the proppant particulates can be selected based on the size of the fractures and other factors known to those skilled in the art with the benefit of this disclosure.

Any type of primary proppant particulate known to those skilled in the art to be suitable for use in propping open primary fractures in subterranean formations can be included in the fracturing fluid. Suitable primary proppant particulates include all shapes of materials, including substantially spherical materials, low to high aspect ratio materials, fibrous materials, polygonal materials (such as cubic materials), and mixtures thereof. For example, suitable primary proppant particulates can be selected from the group of sand, walnut hulls, resin pre-coated proppant particulates, man-made proppant particulates, and mixtures thereof. For example, a suitable primary proppant particulate for use herein is natural sand.

For example, primary proppant particulates can be included in the fracturing fluid in accordance with the disclosed method in an amount in the range of from about 0.01 pound to about 6 pounds per 1000 gallons of the fracturing fluid. For example, the primary proppant particulates can be mixed with the fracturing fluid in an amount in the range of from about 0.01 pound to about 1 pound per 1000 gallons of the slurry. For example, primary proppant particulates can be mixed with the fracturing fluid in an amount in the range of from about 0.025 pound to about 0.1 pound per 1000 gallons of the slurry.

The micro-proppant particulates used in the disclosed method can be any type of micro-proppant particulates suitable for use in propping open microfractures in subterranean formations as known to those skilled in the art with the benefit of this disclosure. Suitable micro-proppant particulates include all shapes of materials, including substantially spherical materials, low to high aspect ratio materials, fibrous materials, polygonal materials (such as cubic materials), and mixtures thereof. For example, the types of proppant particulates typically used as primary proppant particulates can be used as micro-proppant particulates. For example, micro-proppant particulates can be delivered to the well site in slurry form. The micro-proppant particulates can also be generated in the fracturing fluid.

Examples of micro-proppant particulates that can be used include sand (for example natural sand), bauxite, ceramic proppant materials, glass materials, polymer materials, polytetrafluoroethylene materials, fly ash, silica flour, seed shell pieces, fruit pit pieces, composite particulates including wood composite particulates, nut shell pieces including walnut hulls (for example, ground walnut hulls), resin pre-coated proppant particulates such as resin pre-coated sand, man-made non-degradable proppant particulates, and mixtures thereof. Examples of man-made proppant particulates include bauxite, ceramics, and polymeric composite particulates. Suitable composite particulates include a binder and a filler material wherein suitable filler materials include silica, alumina, fumed carbon, carbon black, graphite, mica, titanium dioxide, meta-silicate, calcium silicate, kaolin, talc, zirconia, boron, fly ash, hollow glass microspheres, solid glass, and combinations thereof.

For example, the micro-proppant particulates can be selected from the group consisting of silica flour, glass beads, fly ash, ceramics, bauxite, polymer materials, polymeric composites, mica, and combinations thereof. For example, the micro-proppant particulates can be selected from the group consisting of silica flour, fly ash, ceramics, polymeric composites and combinations thereof. Examples of commercially available micro-proppant particulates that can be used in the disclosed method include micro-proppant particulates manufactured by Zeeospheres Ceramics, LLC and sold as “Zeeospheres™ N-200” and “Zeeospheres™ N-600.”

For example, micro-proppant particulates can be included in the fracturing fluid in accordance with the disclosed method in an amount at least sufficient to place micro-proppant particulates in a microfracture. For example, the micro-proppant particulates can be mixed with the fracturing fluid in accordance with the disclosed method in an amount in the range of from about 0.01 pound to about 2 pounds per 1000 gallons of the fracturing fluid. For example, the micro-proppant particulates can be mixed with the fracturing fluid in an amount in the range of from about 0.05 pound to about 1.0 pound per 1000 gallons of the fracturing fluid. For example, the micro-proppant particulates can be mixed with the fracturing fluid in an amount in the range of from about 0.1 pound to about 0.5 pound per 1000 gallons of the fracturing fluid.

Ceasing pumping of the proppant slurry into the subterranean formation in accordance with the disclosed method causes the pressure at which the proppant slurry is pumped into the formation to fall below the fracture gradient of the formation. For example, once pumping of the proppant slurry into the formation is ceased, or the pressure in the formation is otherwise caused to fall below the fracture gradient of the formation, the fracture(s) in the formation tend to close on top of the proppant particulates therein. The conductive channels formed by the proppant particulates allow hydrocarbons to flow through the fracture network to the wellbore and ultimately to the surface where they can be recovered.

In accordance with the disclosed method, when pumping of the fracturing fluid into the formation is ceased or the pressure at which the fracturing fluid is pumped into the formation is otherwise allowed to fall below the fracture gradient of the formation, the fracture formed in the formation may tend to close. However, the proppant particulates prevent the fracture from fully closing or otherwise provide conductive fluid pathways through the fracture. The resulting propped fracture provides one or more conductive channels through which fluids in the formation can flow toward the wellbore. As used herein and in the appended claims, unless stated otherwise, the term “fracture” includes and encompasses primary fractures and microfractures.

The gel formed in the fracturing fluid can be broken as described above and disclosed herein.

The method can further comprise removing the broken gel from the well. The broken gel can be removed from the well as disclosed herein.

In another embodiment, the method disclosed herein is a method of forming a gravel pack in a well. For example, the gravel pack can be installed proximate to an unconsolidated or loosely consolidated production interval in order to mitigate the production of particulate material such as sand with hydrocarbons from the well.

In this embodiment, the well treatment fluid is a gravel packing fluid and further comprises gravel. As used herein and in the appended claims, the term “gravel” means and includes any type of particulate material that can be used to form the particulate screen of a gravel pack. Examples of gravel that can be included in the well treatment fluid disclosed herein include silica particulate materials (for example, sand), alumina particulate materials, synthetic polymer particulate materials, metal oxide particulate materials and other materials used as proppant particulate materials. For example, the gravel can be large grain sand. For example, the gravel can have a D50 particle size distribution in the range of from about 50 microns to about 5 millimeters. For example, the gravel can have a D50 particle size distribution in the range of from about 100 microns to about 2 millimeters. The type and size of the gravel can be selected based on the type and size of the particulate material to be screened by the proppant pack and other factors known to those skilled in the art with the benefit of this disclosure.

The method of forming a gravel pack in a well comprises: placing a sand control screen proximate to a production interval that contains a particulate material; providing the gravel packing fluid; allowing a gel to form in the gravel packing fluid; pumping the gravel packing fluid into the well; placing gravel around the sand control screen to form a gravel pack proximate to the production interval; ceasing pumping of the gravel pack slurry into the wellbore; and breaking gel in the fracturing fluid. The method can further comprise removing broken gel from the well.

As used herein and in the appended claims, a “sand control screen” means a screen, slotted liner or other type of apparatus or structure that can be used to form a gravel pack in a well. A “production interval” means a formation or a zone or interval thereof that contains hydrocarbons to be produced by the well. “Proximate to” means adjacent to, near or in the production interval. A particulate material means sand or another type of particulate material.

The sand control screen can be placed proximate to the production interval by any method known to those skilled in the art with the benefit of this disclosure. For example, the sand control screen can be lowered into the wellbore on a work string and placed in the desired position. For example, the sand control screen can be formed of metal or steel.

The gravel pack slurry can be provided, for example, by mixing the components of the gravel packing fluid together at the site of the well as described above and known to those skilled in the art with the benefit of this disclosure. For example, the gravel can be included in the fracturing fluid in an amount at least sufficient to form a gravel pack in the well.

A gel can be allowed to form in the gravel packing fluid by mixing the aqueous base fluid, polymer gelling agent, gel stabilizer (if used), gel crosslinker (if used), and gel breaker (if used) of the well treatment fluid together, as described above. For example, the gravel can be mixed with the well treatment fluid on the fly.

The gravel packing fluid can be pumped into the well in any manner known to those skilled in the art with the benefit of this disclosure. The gravel packing fluid is pumped through the wellbore and through one or more access conduits into the formation.

Gravel can be placed around the sand control screen to form a gravel pack proximate to the production interval by pumping the gravel packing fluid into the well (for example, down the work string) and into the well annulus formed between the sand control screen and the perforated well casing (if the well is cased) or open hole production zone (if the well is not cased). For example, the base fluid either flows into the formation or returns to the surface by flowing through the sand control screen or both. In either case, the gravel is deposited concentrically around the sand control screen to form a gravel pack. For example, the gravel pack is highly permeable to the flow of hydrocarbon fluids but blocks the flow of the particulate material carried by hydrocarbon fluids to be produced from the production interval.

Gel in the gravel packing fluid can be broken as described above herein.

The method can further comprise removing the broken gel from the well as disclosed herein.

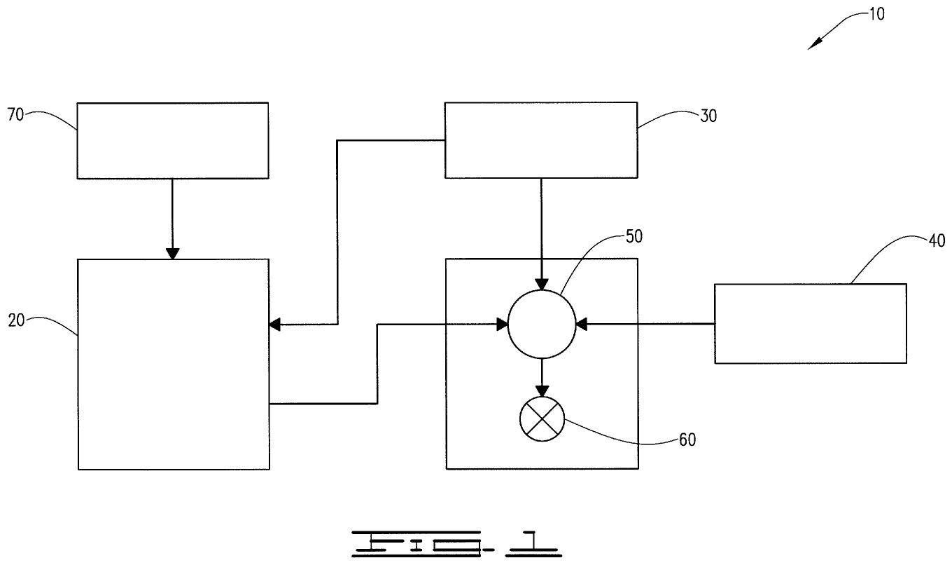

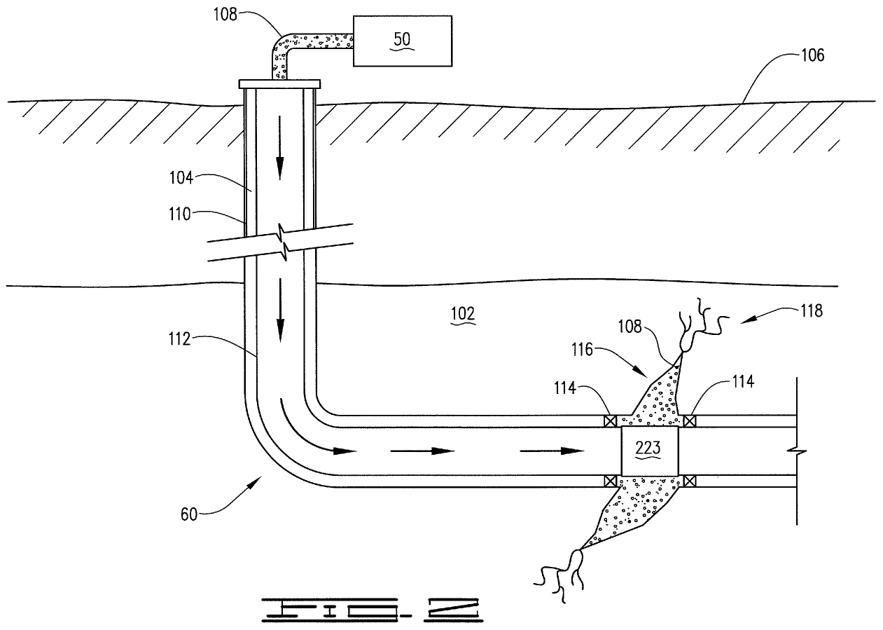

The exemplary fluids, compositions and methods disclosed herein may directly or indirectly affect one or more components or pieces of equipment associated with the preparation, delivery, recapture, recycling, reuse, and/or disposal of the disclosed fluids, compositions and methods. FIGS. 1 and 2 illustrate a typical fracturing operation.

For example, and with reference to FIG. 1, the disclosed fluids, compositions and methods may directly or indirectly affect one or more components or pieces of equipment associated with an exemplary fracturing system 10, according to one or more embodiments. In certain instances, the system 10 includes a fracturing fluid producing apparatus 20 (for example, for producing a pad fracturing fluid and/or proppant slurry for use in the disclosed method), a fluid source 30, a proppant source 40, and a pump and blender system 50. The system 10 resides at the surface at a well site where a well 60 is located. For example, the fracturing fluid producing apparatus 20 can combine a gel precursor with fluid (e.g., liquid or substantially liquid) from fluid source 30, to produce a hydrated fracturing fluid (for example, the pad fluid and/or proppant slurry of the method disclosed herein) that is used to fracture the formation. The hydrated fracturing fluid can be a fluid for ready use in a fracture stimulation treatment of the well 60 or a concentrate to which additional fluid is added prior to use in a fracture stimulation of the well 60. In other instances, the fracturing fluid producing apparatus 20 can be omitted and the fracturing fluid sourced directly from the fluid source 30. In certain instances, as discussed above, the fracturing fluid may comprise water, a hydrocarbon fluid, a polymer gel, foam, air, wet gases and/or other fluids.

The proppant source 40 can include and provide the proppant (including the micro-proppant particulates and primary proppant particulates of the disclosed method) for combination with the fracturing fluid (for example, the pad fluid and proppant slurry) as appropriate. The system may also include an additive source 70 that can provide the degradable metal alloy milling waste particulates of the disclosed well treatment fluid and one or more additives (e.g., gelling agents, weighting agents, and/or other optional additives as discussed above) to alter the properties of the fracturing fluid (for example, the pad fluid and/or proppant slurry). For example, additives from the additive source 70 can be included to reduce pumping friction, to reduce or eliminate the fluid's reaction to the geological formation in which the well is formed, to operate as surfactants, and/or to serve other functions.

For example, the pump and blender system 50 can receive the fracturing fluid (for example, the base carrier fluid) and combine it with other components, including proppant particulates from the proppant source 40 and/or additional fluid and other additives from the additive source 70. The resulting mixture may be pumped down the well 60 under a pressure sufficient to create or enhance one or more fractures in a subterranean zone, for example, to stimulate production of fluids from the zone. Notably, in certain instances, the fracturing fluid producing apparatus 20, fluid source 30, proppant source 40 and/or additive source 70 may be equipped with one or more metering devices (not shown) to control the flow of fluids, degradable metal alloy milling waste particulates, proppant particulates, and/or other compositions to the pump and blender system 50. Such metering devices may permit the pump and blender system 50 to source from one, some or all of the different sources at a given time, and may facilitate the preparation of fracturing fluids in accordance with the present disclosure using continuous mixing or “on the fly” methods. Thus, for example, the pump and blender system 50 can provide just fracturing fluid (for example, the pad fluid) into the well at some times, just proppant slurry at some times, just proppant particulates at other times, and combinations of those components at yet other times.

FIG. 2 shows the well 60 during a fracturing operation in a portion of a subterranean formation of interest 102 (for example, a subterranean zone) surrounding a wellbore 104. For example, the formation of interest can include one or more subterranean formations or a portion of a subterranean formation.

The wellbore 104 extends from the surface 106, and the fracturing fluid 108 (for example, the pad fluid and proppant slurry) is applied to a portion of the subterranean formation 102 surrounding the horizontal portion of the wellbore. Although shown as vertical deviating to horizontal, the wellbore 104 may include horizontal, vertical, slanted, curved, and other types of wellbore geometries and orientations, and the fracturing treatment may be applied to a subterranean zone surrounding any portion of the wellbore. The wellbore 104 can include a casing 110 that is cemented or otherwise secured to the wellbore wall. The wellbore 104 can be uncased or include uncased sections. Perforations can be formed in the casing 110 to allow fracturing fluids and/or other materials to flow into the subterranean formation 102. In cased wells, perforations can be formed using shaped charges, a perforating gun, hydro jetting and/or other tools.

The well is shown with a work string 112 depending from the surface 106 into the wellbore 104. The pump and blender system 50 is coupled to a work string 112 to pump the fracturing fluid 108 into the wellbore 104. The work string 112 may include coiled tubing, jointed pipe, and/or other structures that allow fluid to flow into the wellbore 104. The work string 112 can include flow control devices, bypass valves, ports, and or other tools or well devices that control a flow of fluid from the interior of the work string 112 into the subterranean zone 102. For example, the work string 112 may include ports adjacent the wellbore wall to communicate the fracturing fluid 108 directly into the subterranean formation 102, and/or the work string 112 may include ports that are spaced apart from the wellbore wall to communicate the fracturing fluid 108 into an annulus in the wellbore between the work string 112 and the wellbore wall.

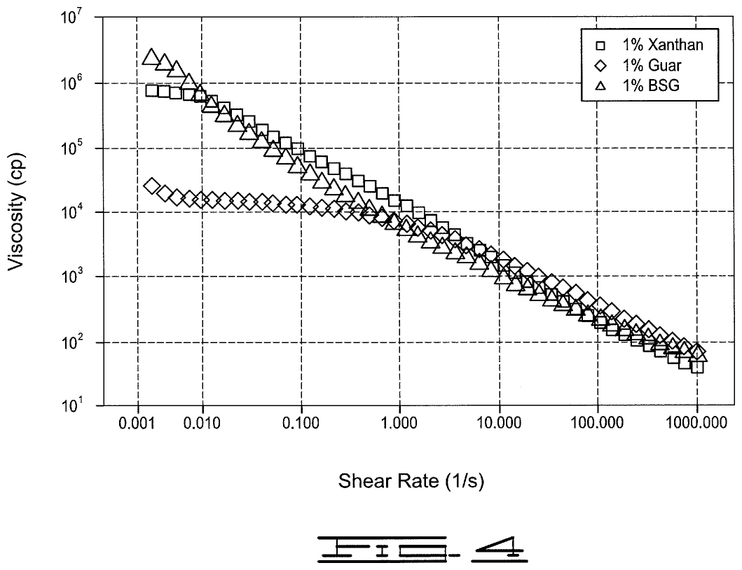

The work string 112 and/or the wellbore 104 may include one or more sets of packers 114 that seal the annulus between the work string 112 and wellbore 104 to define an interval of the wellbore 104 into which the fracturing fluid 108 will be pumped. FIG. 4 shows two packers 114, one defining an uphole boundary of the interval and one defining the downhole end of the interval.

When the fracturing fluid 108 (for example, the pad fracturing fluid) is introduced into wellbore 104 (e.g., in FIG. 4, the area of the wellbore 104 between packers 114) at a sufficient hydraulic pressure, one or more primary fractures 116 and microfractures 118 are created in the subterranean zone 102. As shown, the microfractures have propagated from or near the ends and edges of the primary fractures 116. The primary proppant particulates in the fracturing fluid 108 (for example, the proppant slurry) enter the fractures 116 where they may remain after the fracturing fluid flows out of the wellbore, as described above. These primary proppant particulates may “prop” fractures 116 such that fluids may flow more freely through the fractures 116. Similarly, the micro-proppant particulates in the fracturing fluid 108 (for example, the pad fluid and the proppant slurry) enter the fractures 118 where they may remain after the fracturing fluid flows out of the wellbore, as described above. The primary proppant particulates and micro-proppant particulates “prop” fractures 116 and 118, respectively, such that fluids may flow more freely through the fractures 116 and 118.

While not specifically illustrated herein, the disclosed fluids, compositions and methods may also directly or indirectly affect any transport or delivery equipment used to convey the compositions to the fracturing system 10 such as, for example, any transport vessels, conduits, pipelines, trucks, tubulars, and/or pipes used to fluidically move the compositions from one location to another, any pumps, compressors, or motors used to drive the compositions into motion, any valves or related joints used to regulate the pressure or flow rate of the compositions, and any sensors (i.e., pressure and temperature), gauges, and/or combinations thereof, and the like.

### EXAMPLES

The following examples illustrate specific embodiments consistent with the present disclosure but do not limit the scope of the disclosure or the appended claims. Concentrations and percentages are by weight unless otherwise indicated.

### Example I

### Extraction of Basil Seed Gum from Basil Seeds

Basil seed gum was extracted from basil seeds as follows:

Basil seeds were soaked and swelled in distilled water at 25° C. at a water/seed ratio of 20:1. The distilled water was adjusted to a pH of 8 using 0.01 moles per liter of a sodium hydroxide (NaOH) solution. The mixture was stirred with a rod paddle mixer at 50° C. until the seeds were completely swelled (20 minutes of agitation at 1000 rpm). After the stirring process, a blade mixer was used for about 10 minutes at a high rpm to peel off the polysaccharide surface of the grain. The entire mixture was then placed and run in a centrifuge to separate a concentrated basil seed gum gel (which settled out) from the remaining components (a supernatant clear liquid). The concentrated basil seed gum gel portion was then freeze dried.

### Example II

### Polymer Gel Preparation/Rheology

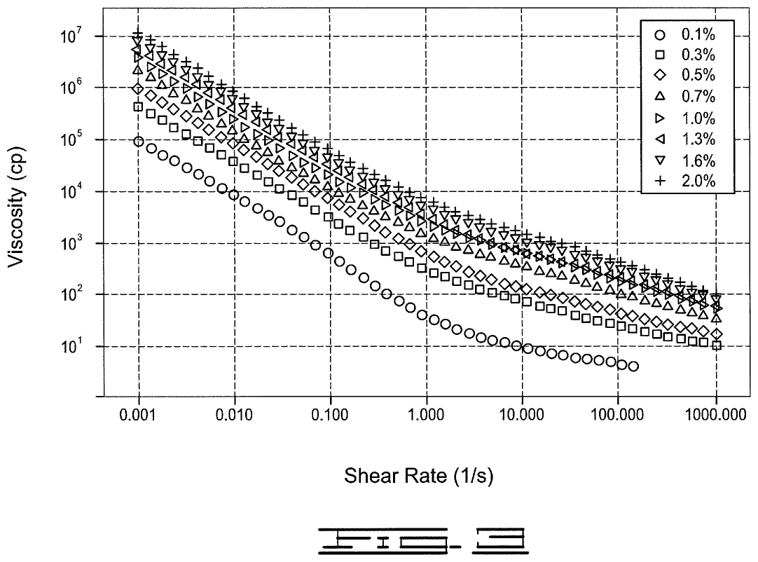

Various basil seed gum gels having varying degrees of basil seed gum polymer gelling agent loading were prepared by hydrating various amounts of the basil seed gum polymer gelling agent with water. The shear thinning properties of the basil seed gum gels at different concentrations (0.1-2%) are shown by the FIG. 3 herein.

As shown by FIG. 3, the basil seed gum gelling agent has shear thinning properties which, for example, can help in reducing the pumping pressure needed in a fracturing treatment. Also, the viscosity of the gel formed by the basil seed gum gelling agent increases with an increase in the polymer loading. For example, at lower shear rates the viscosity of the basil seed gum gelling agent is high enough to suspend proppant in fracturing and gravel pack operations.

### Example III

### Comparison Tests

Similar tests were done to compare the basil seed gum polymer gelling agent with other polymer gelling agents, namely, guar and xanthan. The results are shown by FIG. 4 herein.

As shown by FIG. 4, it is clear that the low shear viscosity of basil seed gum is high compared to guar gum and equivalent to xanthan gum.

### Example IV

### Rheology at Higher Temperatures

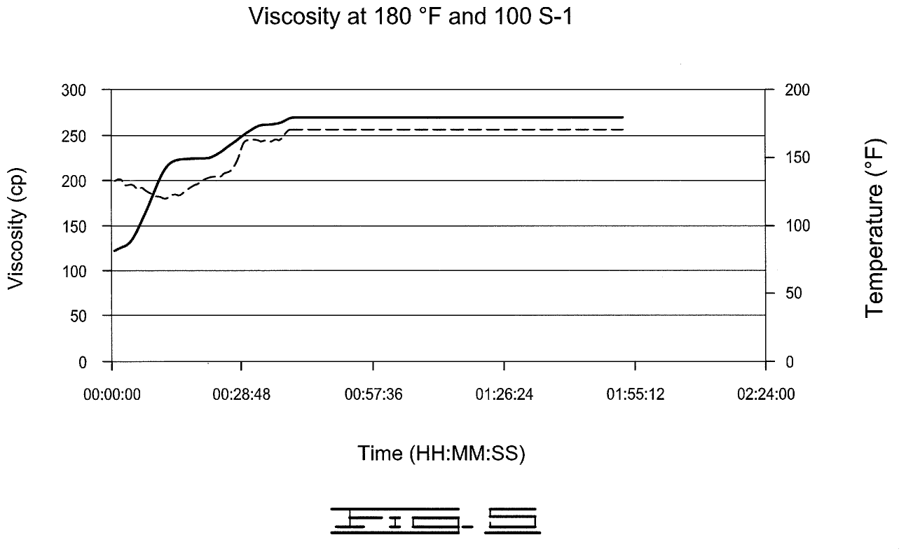

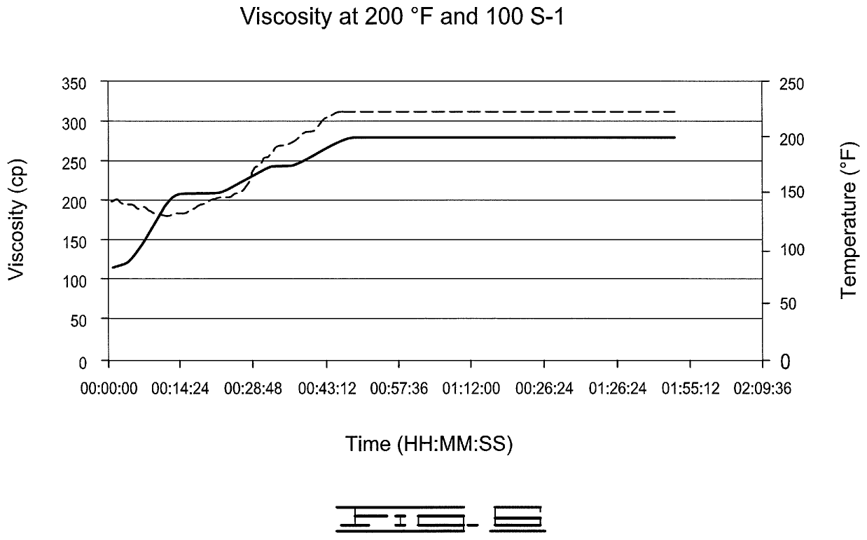

In order to understand the rheological behavior of basil seed gum at high temperature, the basil seed gum polymer gelling agent was tested at 180° F. and 200° F. The results of the tests are shown by FIGS. 5 and 6 herein. In FIGS. 5 and 6, the solid line represents the temperature (° F.), whereas the dotted line represents the viscosity (cp).

As shown by FIGS. 5 and 6, the viscosity of the basil seed gum gel formed by the basil seed gum gelling agent increases as the temperature increases showing that the gelling agent has a thermo-thickening response.

### Example V

### Oscillatory Rheological Tests

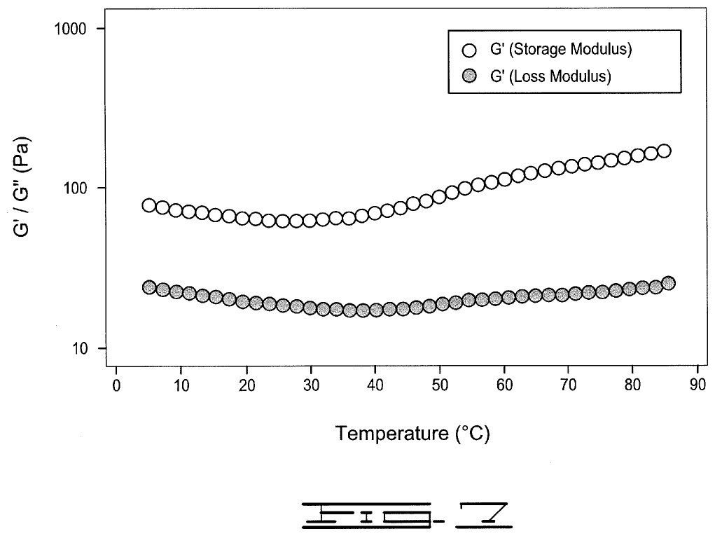

In order to confirm the thermo-thickening nature of the basil seed gum gelling agent, oscillatory rheological tests were performed on basil seed gum formed by the basil seed gum gelling agent. The results are shown by FIG. 7 herein.

As shown by FIG. 7, the storage modulus increases with an increase in temperature which suggests that the holding capacity of the basil seed gum gel increases with increasing temperature. The above test results also confirm the thermo-thickening effects of the basil seed gum gelling agent. Although not wanting to be bound by any particularly theory, a possible reason for the thermo-thickening effect of the basil seed gum gelling agent could be increased hydrophobic associations at increased temperatures.

### Example VI

### Sand Settling Tests

In order to understand the sand settling capacity of the fluid system, a sand settling test was performed. In carrying out the test, approximately 60 grams of sand having an average particle size of about 20/40 mesh were placed in a 100 mL beaker together with a treatment fluid containing water and about 1 gram of basil seed gum (approximately 1 wt. % basil seed gum based on the weight of the water). The contents in the beaker were mixed together and a basil seed gum gel was formed in the treatment fluid. The sand was suspended in the basil seed gum gel.

The contents of the beaker were then heated to and maintained at approximately 200° F. for one hour. After the one hour test period, it was observed that the sand was still nicely suspended in the gel.

### Example VII

### Break Test

Next, a treatment fluid gelled using the basil seed gum gelling agent was prepared and broken.

The gelled treatment fluid was prepared by combining 100 mL water and about 1 g basil seed gum gelling agent (about 1 wt. % basil seed gum gelling agent based on the weight of the water) in a beaker. The contents in the beaker were mixed together and a basil seed gum gel was formed in the treatment fluid.

Next, approximately 0.2 wt. % of sodium persulfate (a water soluble oxidizing breaker), based on the total weight of the treatment fluid, was added to the gelled treatment fluid and mixed therein. After a few minutes, it was observed that the gel had cleanly broken.

Therefore, the present compositions and methods are well adapted to attain the ends and advantages mentioned, as well as those that are inherent therein. The particular example disclosed above is illustrative only, as the present treatment additives and methods may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered or modified, and all such variations are considered within the scope and spirit of the present treatment additives and methods. While compositions and methods are described in terms of “comprising,” “containing,” “having,” or “including” various components or steps, the compositions and methods can also, in some examples, “consist essentially of” or “consist of” the various components and steps. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee.

What is claimed is:

1. A method of treating a well, comprising:
introducing a well treatment fluid into the well, said well treatment fluid including:
an aqueous base fluid; and
a polymer gelling agent, wherein said polymer gelling agent is selected from the group of basil seed gum, derivatives of basil seed gum, and combinations thereof;
allowing a gel to form in said well treatment fluid;
allowing said gelled well treatment fluid to treat the well; and
breaking gel formed in said well treatment fluid.

2. The method of claim 1, further comprising removing broken gel from said well.

3. The method of claim 1, wherein said well treatment fluid further comprises a gel stabilizer.

4. The method of claim 1, wherein said well treatment fluid further comprises a gel crosslinker.

5. The method of claim 1, wherein said well treatment fluid further comprises a gel breaker.

6. The method of claim 1, wherein said polymer gelling agent is basil seed gum.

7. The method of claim 1, wherein said polymer gelling agent is present in said well treatment fluid in an amount in the range of from about 0.001% to about 10% by weight, based on the total weight of said well treatment fluid.

8. A method of fracturing a subterranean formation, comprising:
providing a fracturing fluid, the fracturing fluid including:
an aqueous base fluid;
a polymer gelling agent, wherein said polymer gelling agent is selected from the group of basil seed gum, derivatives of basil seed gum, and combinations thereof; and
a plurality of proppant particulates;
pumping said fracturing fluid into the formation at a pressure above the fracture gradient of the formation to form a fracture in the formation;
allowing a gel to form in said fracturing fluid;
placing proppant particulates in the fracture;
ceasing pumping of said fracturing fluid into the formation; and
breaking gel formed in said fracturing fluid.

9. The method of claim 8, wherein said polymer gelling agent is basil seed gum.

10. A method of forming a gravel pack in a well, comprising:
placing a sand control screen proximate to a production interval that contains a particulate material;
providing a gravel packing fluid, the gravel packing fluid including:
an aqueous base fluid;
a polymer gelling agent, wherein said polymer gelling agent is selected from the group of basil seed gum, derivatives of basil seed gum, and combinations thereof; and
gravel;
allowing a gel to form in said gravel packing fluid;
pumping said gravel packing fluid into the well;
placing gravel around said sand control screen to form a gravel pack proximate to said production interval;
ceasing pumping of said gravel packing fluid into said wellbore; and
breaking gel in said gravel packing fluid.

11. The method of claim 10, wherein said polymer gelling agent is basil seed gum.

12. The method of claim 10, wherein the gravel packing fluid is pumped into said well using one or more pumps.

13. A well treatment fluid, comprising:
an aqueous base fluid; and
a polymer gelling agent, wherein said polymer gelling agent is selected from the group of basil seed gum, derivatives of basil seed gum, and combinations thereof.

14. The well treatment fluid of claim 13, wherein the well treatment fluid is a fracturing fluid or a gravel packing fluid.

15. The well treatment fluid of claim 13, wherein said aqueous base fluid is salt-containing water.

16. The well treatment fluid of claim 13, wherein said polymer gelling agent is basil seed gum.

17. The well treatment fluid of claim 13, wherein said polymer gelling agent is present in said well treatment fluid in an amount in the range of from about 0.001% to about 10% by weight, based on the total weight of said treatment fluid.

18. The well treatment fluid of claim 13, wherein said polymer gelling agent is present in said well treatment fluid in an amount in the range of from about 0.01% to about 5% by weight, based on the total weight of said treatment fluid.

19. The well treatment fluid of claim 13, further comprising a gel stabilizer.

20. The well treatment fluid of claim 13, further comprising a gel crosslinker.

21. The well treatment fluid of claim 13, further comprising a gel breaker.
